(19) United States
(12) Patent Application Publication
(10) Pub. No.: US 2005/0264640 A1
(43) Pub. Date: Dec. 1, 2005

(54) Color control system and color control method

(75) Inventor: Shigeyuki Kitazawa, Kawaguchi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/134,459

(22) Filed: May 23, 2005

(30) Foreign Application Priority Data
May 27, 2004 (JP) JP2004-156973

(51) Int. Cl. B41J 2/315; B41J 2/32

(52) U.S. Cl. 347/171

(57) ABSTRACT

A color management system for controlling output colors of plural color proofs outputted in succession during a period from receiving of an order of printing to finishing of the printing, including: a measuring section to measure an output color of the plural color proofs; a storing section to store a measured value of the output color of the color proof, and sequence information for identifying a sequential order in which the measured output color of the color proof is outputted, in such a way that the measured values and the sequence information correspond each other; and an information generating section to generate information showing a condition of the output color for each of the sequential order based on the measured values stored in the storing section.

This application is based on Japanese Patent Application No. 2004-156973 filed on May 27, 2004 in Japanese Patent Office, the entire content of which is hereby incorporated by reference.

### BACKGROUND OF THE INVENTION

1. Field of the Invention

The present invention relates to a color control system for controlling output colors of a plurality of color proofs outputted in succession during a period from receiving an order of printing to finishing the order, and to a color control method.

2. Background of the Technology

Heretofore, in steps of proofing in a printing process, color proofs representing trial prints are outputted and are used for proofing, for primary three uses including (1) confirmation of internal errors in a job site, namely, in-house proof, (2) outer proof submitted to a person who places an order or a designer for confirming the result of a print, and (3) a print sample presented to a chief of a printing press as a sample of a final printed matter. Those conducted in outer proof are called a first proof, a second proof, a third proof . . . , in the order of proofing.

Then, by using these color proofs, the result or the finish of the prints are confirmed in advance, by inspecting whether there is an error in a layout of the copy film or not, whether there is an error in a color or not, and whether there is an error of a character or not.

Therefore, it is desired that color and density of the outputted material from an output apparatus are made to be constant. For example, there is an apparatus (e.g., see Patent Document 1) wherein color management is conducted for a target output apparatus by providing ICC profile for conducting color management for a printing press or a printer representing an output apparatus, based on colorimetric results of color patches on the target output apparatus, and by providing diagnosis information based on colorimetric results for those outputted.

Further, the output apparatus is not necessarily limited to a single unit, and plural units are sometimes present, and its types include DDCP (Direct Digital Color Proof), an electrophotographic printer, an inkjet printer and a flatbed proof press. Therefore, color management for each output apparatus is conducted as stated above, and there is a system (e.g., see Patent Document 2) wherein results of measurements for color patches outputted from the output apparatus are stored, then, the stored colorimetric results are processed or analyzed to provide information including output level of colors of the output apparatus, comparison of output colors between output apparatuses and aging comparison between output colors.
(Patent Document 1 TOKKAI No. 2003-46794
(Patent Document 2 TOKKAI No. 2003-304365

On the other hand, plural color proofs are outputted in succession during a period from receiving an order of printing to finishing the order, and they are used for the proofing mentioned above. However, color proofs are not necessarily prepared by the same output apparatus, and even if they are prepared on the same output apparatus, they are not outputted simultaneously. Therefore, even if color management is carried out in each output apparatus as described in Patent Document 1, an output color of each color proof is different because of the upper limit and the lower limit of the permissible range of the color, a difference of the apparatus and of aging changes, and its difference sometimes becomes a problem.

Information about the output color described in Patent Document 2 is not related to the output color proof but is related to the output apparatus. Therefore, when a comparison of output colors of respective color proofs is tried in the case of a problem of a difference of a color, the output colors cannot be compared easily. Further, even when confirmation of the conditions of the output colors of the color proofs in the past is tried to avoid the problem of color differences, the conditions of the output colors cannot be confirmed easily. For example, the output apparatus that prepared the color proof and the date and time of preparation of the color proof had to be investigated, and the output color for the output apparatus and for the date and time had to be read from the aforementioned information provided.

### SUMMARY OF THE INVENTION

An object of the invention is to provide a color management system wherein output colors of color proofs outputted within a period from receiving an order of printing to finishing the order can be controlled easily, and to provide a color management method thereof.

One aspect of the embodiment to solve the aforementioned problem is a color management system for managing output colors of plural color proofs outputted in succession in a period from receiving an order of printing to finishing the order, wherein, there are provided a measuring section to measure output colors of the color proofs, a storage section to store measured values of outputted colors of the color proofs to be measured by the measuring section and the order information for discriminating the order in which the color proofs to be measured were outputted, in a way that the measured values and the order information are corresponded each other, and an information making section that makes information showing the conditions of output colors in the order in which the color proofs were outputted, based on the measured values stored in the storing section.

### BRIEF DESCRIPTION OF THE DRAWINGS

FIG. 1 is a functional block diagram showing a system structure of a color management system related to the invention.

FIG. 2 is an illustration showing the structure of a color patch.

FIG. 3(a) is an illustration showing an example of a color proof provided with the color patch shown in FIG. 2.

FIG. 3(b) is an illustration showing an example of a color proof provided with the color patch shown in FIG. 2.

FIG. 4 is a flow chart showing the procedures of measurement and storage for the color patch related to the invention.

FIG. 5 is a diagram showing an example of a screen displayed on a display section of a terminal apparatus of the color management system.

FIG. 6 is an illustration for illustrating measured data and measurement target information to be stored in the storage section.

FIG. 7 is a flow chart showing the procedures of providing output color comparing information related to the invention.

FIG. 8(a) is a diagram showing an example of a screen displayed by a display section of a terminal apparatus of the color management system.

FIG. 8(b) is a diagram showing another example of a screen displayed by a display section of a terminal apparatus of the color management system.

FIG. 9 is a flow chart showing the procedures of providing output color comparing information related to the invention.

FIG. 10 is a flow chart showing the procedures of making output color comparing information related to the invention.

FIG. 11 is a diagram showing an example of output color comparing information made by the color management system related to the invention.

FIG. 12 is a diagram showing an example of output color comparing information made by the color management system related to the invention.

FIG. 13 is a diagram showing an example of output color comparing information made by the color management system related to the invention.

FIG. 14 is a diagram showing an example of output color comparing information made by the color management system related to the invention.

FIG. 15 is a diagram showing an example of output color comparing information made by the color management system related to the invention.

### DETAILED DESCRIPTION OF THE PREFERRED EMBODIMENT

The problems stated above can be solved by the following embodiments.

(1) A color management system for controlling output colors of plural color proofs outputted in succession in a period from receiving of an order of printing to finishing of the order, wherein, there are provided a measuring section to measure output colors of the color proofs, a storage section to store measured values of output colors of the color proofs to be measured by the measuring section and the sequence information for discriminating the sequence in which the color proofs to be measured were outputted, in a way that the measured values and the sequence information correspond each other, and an information generating section that makes information showing the conditions of output colors in the order in which the color proofs were outputted, based on the measured values stored in the storing section.

(2) A color management system for controlling output colors of plural color proofs outputted in succession in a period from receiving of an order of printing to finishing of the order, wherein, there are provided a measuring section to measure output colors of the color proofs, a storage section to store measured values of output colors of the color proofs to be measured by the measuring section, order information for discriminating the orders and the sequence information for discriminating the sequence of outputting, in a way that the measured values, the order information and the sequence information correspond each other, and an information generating section that receives the order information showing an order, then, extracts measured values relating to the aforesaid order stored in the storing section and makes information showing the state of output color in each order through which the color proof was outputted about the aforesaid order, based on the extracted measured values.

(3) A color management system for controlling output colors of plural color proofs outputted at any one of plural sites in succession in a period from receiving of an order of printing to finishing of the order, wherein, there are provided plural terminal apparatuses which are arranged on respective sites and have a measured value transmitting section that transmits measured values of output color of the color proof to be measured by the measuring section that measures output color of the color proof, order information for identifying the order of printing for which the color proof is outputted and the sequence information for discriminating the outputted sequential order, and management server having a storage section that is connected with plural terminal apparatuses through the network and stores the measured values to be transmitted and the sequence information in a way that both of them may correspond to each other, and an information generating section that makes, based on the measured values stored in the storage section, information showing the state of output color in each order in which the color proof was outputted, for browsing with the terminal apparatus.

(4) A color management system for controlling output colors of plural color proofs outputted at any one of plural sites in succession in a period from receiving of an order of printing to finishing of the order, wherein, there are provided plural terminal apparatuses which are arranged on respective sites and have a measured value transmitting section that transmits measured values of output color of the color proof to be measured by the measuring section that measures output color of the color proof, the order information for identifying the order of printing for which the color proof is outputted and the sequence information for identifying the outputted order, and a management server having a storage section that is connected with plural terminal apparatuses through the network and stores the measured values transmitted, the order information and the sequence information in a way that they may correspond to each other, and an information making section that receives the order information showing an order, then, extracts the measured values relating to the aforesaid order stored in the storage section, and makes, based on the extracted measured values, information showing the state of output color in each order in which the color proof was outputted for the aforesaid sequential order, for browsing from the terminal apparatus.

(5) It is characterized that the state of output color is represented by an one of a density value, a value of a color system, a dot gain value or a trapping rate.

(6) It is characterized that the color proof is outputted together with color patches, which include one or plural colors and are provided on the color proof.

(7) A color management method for controlling output colors of plural color proofs outputted in succession in a period from receiving of an order of printing to finishing of the order, wherein, there are included a step to measure output colors of the color proofs, a step to store measured values of output colors of the color proofs to be measured and sequence information for discriminating the sequence in which the color proofs to be measured were outputted in a way that both of them may correspond to each other, and a step to generate, based on the measured values stored, information showing the state of the output color in each sequence in which the color proof was outputted.

(8) A color management method for controlling output colors of plural color proofs outputted in succession in a period from receiving of an order of printing to finishing of the order, wherein, there are included a step to measure output colors of the color proofs, a step to store measured values of output colors of the color proofs to be measured, order information for discriminating the order of the color proof to be measured and sequence information for discriminating the sequential order for outputting in such a way that they may correspond to each other, a step to receive an order information showing an order and to extract the measured values relating to the aforesaid order stored in the storage section, and a step to make, based on the extracted measured values, information showing the state of the output color in each sequence order in which the color proof was outputted for the aforesaid order.

(9) A color management method for controlling output colors of plural color proofs outputted in succession at any one of plural sites in a period from receiving of an order of printing to finishing of the order, wherein, in the plural terminal apparatuses arranged at respective sites, there are included a step to measure output colors of the color proofs, a step to transmit measured values of output colors of the color proofs measured, order information for identifying the order of printing for which the color proof is outputted and sequence information for discriminating the sequential order of outputting, and in the control server connected to the plural terminal apparatuses through the network, there are included a step to store the measured values transmitted and the sequence information in a way that both of them may correspond to each other, and a step to generate, based on the measured value stored, information showing the state of output color in each sequential order in which the color proof was outputted for browsing with the terminal apparatus.

(10) A color management method for controlling output colors of plural color proofs outputted in succession at any one of plural sites in a period from receiving of an order of printing to finishing of the order, wherein, in the plural terminal apparatuses arranged at respective sites, there are included a step to measure output colors of the color proofs, a step to transmit measured values of output colors of the color proofs, order information for identifying the order of printing for which the color proof is outputted and sequence information for discriminating the sequential order for outputting, and in the control server connected to the plural terminal apparatuses through the network, there are included a step to store the measured values transmitted, the order information and the sequence information in a way that they may correspond to each other, a step to receive the order information showing an order and to extract the measured values relating to the aforesaid order stored in the storage section and a step to generate, based on the extracted measured value, information showing the state of output color in each sequence order in which the color proof was outputted for the aforesaid order, for browsing with the terminal apparatus.

In the color management system in (1), it is possible to conduct the control of the output color of the color proof, and to compare output colors of each color proof, by storing measured values of output colors of color proofs and sequence information for discriminating the sequence order in which the color proof was outputted in a way that both of them may correspond to each other and by making information showing the state of output color in each sequence order in which the color proof was outputted.

In the color management system in (2), it is possible to control the output color of the color proof for each order, and to compare output colors of each color proof for each order, by storing measured values of output colors of color proofs, an order information for discriminating the order of the color proof and sequence information for discriminating the sequential order for outputting in a way that they may correspond to each other, and by making information showing the state of output color of each sequence order in which a color proof is outputted for one order.

In the color management system in (3), it is possible to control the output color of the color proof outputted at each site, and to compare output colors of each color proof at each site, by transmitting the measured values of output colors for color proofs and sequence information for discriminating the sequence in which the color proof was outputted, in plural terminal apparatuses arranged at respective sites, then, by storing the transmitted measured values and the sequence information in a way that they may correspond to each other, in the management server connected with plural terminal apparatuses through the network, and by making, based on the measured values stored, information showing the state of output color in each sequence order in which the color proof was outputted, for browsing with the terminal apparatus.

In the color management system in (4), it is possible to control the output color of the color proof outputted at each site for each order, and to compare output colors of each color proof for each order at each site, by transmitting the measured values of output colors for color proofs, the order information for discriminating the order of the color proof and sequence information for discriminating the sequential order for outputting, in the plural terminal apparatuses, then, by storing the transmitted measured values, the order information and the sequence information in a way that they may correspond to each other, in the management server connected with plural terminal apparatuses through the network, and by generating, based on the measured values stored, information showing the state of output color in each sequence order in which the color proof was outputted for one order, for browsing from the terminal apparatus.

In the color management system in (5), the state of output color is represented by any one of a density value, a value of a color system, a dot gain value or a trapping rate, thus, the output colors can easily be compared.

In the color management system in (6), color patches provided on the color proof are measured, thus, output colors of the color proof outputted can easily be measured.

In the color management method in (7), it is possible to control output colors of color proofs by storing measured values of output colors of the color proofs and the sequence information for discriminating the sequential order in which the color proof was outputted in a way that both of them may correspond to each other and by generating, based on the measured value stored, information showing the state of an output color for each sequence in which the color proof was outputted.

In the color management method in (8), it is possible to control output colors of color proofs for each order, and to compare the output color of each color proof for each order, by storing the measured values, order information as well as sequence information for discriminating sequential order for outputting, and by generating, based on the measured values stored, information showing the state of output colors for each sequential order in which the color proof was outputted for one order.

In the color management method in (9), it is possible to control output colors of color proofs outputted at respective sites, and to compare the output color of each color proof at each site, by transmitting measured values of output colors of the color proofs and sequence information for discriminating the sequential order in which the color proof was outputted at plural terminal apparatuses arranged at respective sites, then, by storing the transmitted measured values and the sequence information in a way that both of them correspond to each other, at a management server connected to the plural terminal apparatuses through the network, and by generating, based on the measured value stored, information showing the state of output color in each sequential order in which the color proof was outputted, for browsing from the terminal apparatus.

In the color management method in (10), it is possible to control output colors of color proofs outputted at respective sites for each order, and to compare output colors of each color proof at each site for each order, by transmitting measured values of output colors of color proofs, order information for discriminating an order for a color proof and sequence information for discriminating the sequential order for outputting, at plural terminal apparatuses arranged at respective sites, then, by storing the transmitted measured values, the order information and the sequence information in a way that they may correspond to each other, at a management server connected to the plural terminal apparatuses through the network, and by generating, based on the stored measured values, information showing the state of output color in each sequential order in which the color proof was outputted for one order, for browsing from the terminal apparatus.

Preferred Embodiment

A preferred embodiment of the color management system and of the color management method for the same will be explained specifically as follows, referring to the drawings.

The color management system of the invention is one to collect measured values of output colors of plural color proofs which are outputted in succession as a proof within a period from receiving of orders to finishing of the orders, and to provide information (hereinafter referred to as output color comparing information) showing the state of output colors of color proofs in each order.

The structure of the color management system in the present embodiment will be explained in detail as follows, referring to the drawings.

(System Structure)

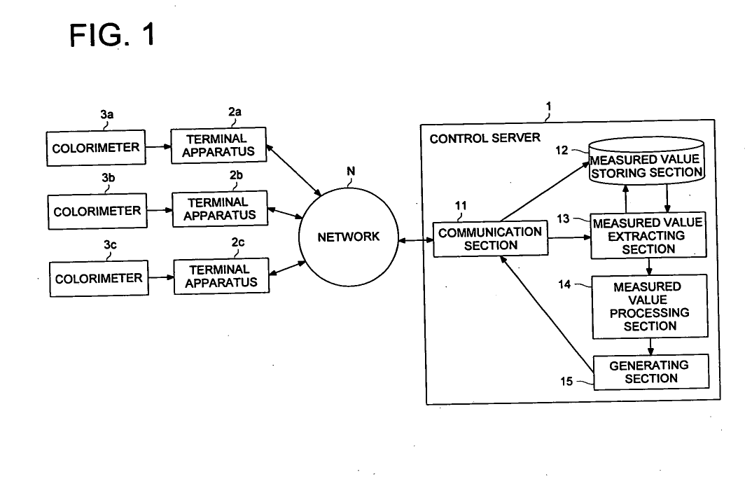

FIG. 1 is a functional block diagram showing the system structure of the present color management system. Management server 1 is connected to terminal apparatuses 2 (2a, 2b and 2c in the drawing) which are arranged at plural sites in remote places through network N such as a private communication line or Internet. Further, each terminal apparatus 2 is connected with each of calorimeters 3 (3a, 3b and 3c) representing a measurement section for measuring hue and density of color proofs outputted from unillustrated apparatus or apparatuses arranged in each site.

In this case, a plurality of sites include, for example, a printing company, a subcontractor of the printing company and a customer, and color proofs to be outputted include color samples which are presented to a printing company by a customer when placing an order and print samples serving as a sample for printing in addition to those used for in-house proof, first proof, second proof and third proof. Further, the color sample, in-house proof, first proof, second proof, third proof and print sample show the sequence in which the color proofs were outputted.

Incidentally, with respect to the number of terminal apparatus 2 and the number of colorimeter 3, any number of them may be arranged, without being limited to three in FIG. 1. Further, unillustrated output apparatuses and calorimeters 3a-3c may be of the products and types which are different each other. As an output apparatus, DDCP, an electrophotographic printer, an inkjet printer and a flatbed proof press can be used.

The terminal apparatus 2 is the so-called computer terminal, and it is provided with an input section such as a key board and a mouse, a display section such as CRT (cathode ray tube) and LCD (liquid crystal display) and an apparatus main body including a computer. Further, the terminal apparatus 2 is equipped with a function as a communication section conducting transmitting-receiving of information and a Web browser function that requests management server 1 to transmit screen information through a communication section and network N, and conducts display with a display section such as CRT and LCD based on screen information received from management server 1, and transmits input by an input section such as a key board and a mouse to the management server 1, and realizes a function as a measured value transmitting section that transmits, to the management server 1, the measured values indicating hue and density of color proofs measured by calorimeter 3 by using the Web browser function, and the measurement target name showing the measured color proofs, and displays output color comparing information transmitted from the management server 1 with a display section.

The management server 1 is the so-called computer terminal, and it is provided with an input section such as a key board and a mouse, a display section such as CRT and LCD and an apparatus main body including a server. Further, management server 1 is equipped with communication section 11 having a function as a communication section conducting transmitting-receiving of information through network N, and with measured value storing section 12 having a function as a storing section that stores measured values transmitted from the terminal apparatus 2 a measurement target name so that both of them may be associated with each other. It is further provided with measured value extracting section 13 that extracts measured values related to the order and with measured value processing section 14 that makes output color comparing information based on the extracted measured values. Further, the management server 1 is provided with generating section 15 that converts the generated information into screen information which can be read by a display section of the terminal apparatus 2. The screen information thus generated is transmitted to the terminal apparatus 2 through communication section 11 and network N. Further, the measured value extracting section 13, the measured value processing section 14 and the generating section 15 constitute an information generating section of the invention.

Owing to the structure stated above, output color comparing information for the color proofs in each order based on the request from each terminal apparatus 2 can be provided (procedures will be described later).

(Color Management Method)

Next, a color management method carried out in the color management system will be explained.

(Measurement of Color Proof)

First, measurement of hue and density of color proofs outputted from an output apparatus will be explained. In the present embodiment, however, color patch P having therein a plurality of colors is outputted, and density, specifically, Dc (cyan density), Dm (magenta density), Dy (yellow density) and Dv (visual density) and values of a color system, specifically, L*a*b* values in CIE L*a*b* color system are measured for each color of the color patch, to be used for comparison which will be explained later. RGB density and three excitation values of X, Y and Z in XYZ color system as values of the color system may also be used, as a matter of course, provided that they show hue and density of color proofs.

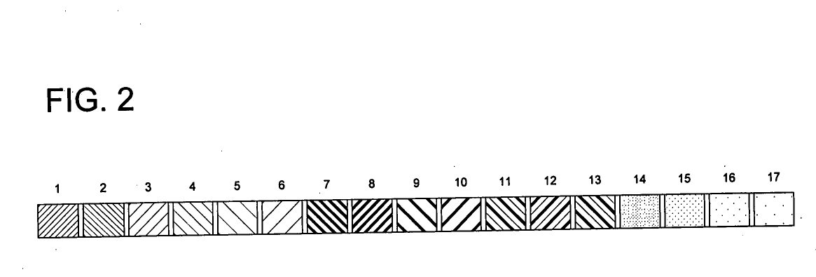

First, an example of the structure of the color patch P mentioned above will be explained. As shown in FIG. 2, 17 colors of C100%, M100%, Y100%, K100%, CMY100%, MY100%, CY100%, CM100%, W (white background), C50%, M50%, Y50%, K50%, CMY10%, CMY20%, CMY40% and CMY70%, for example, are arranged in a line in a sequence of the numbers which are given from the left for explanation. Further, in the case of measurement by the use of measurement screed 21 which will be explained later, measurement is to be conducted in the sequence of given numbers. Though the color patch P has 17 colors in the present example, the number of colors to be used for comparison has only to be one or more. Though both of density and values of the color system are measured in the present example, what is measured may also be either density or a value of the color system, and with respect to output color comparing information which will be described later, the one based on density or the one based on a value of the color system is prepared.

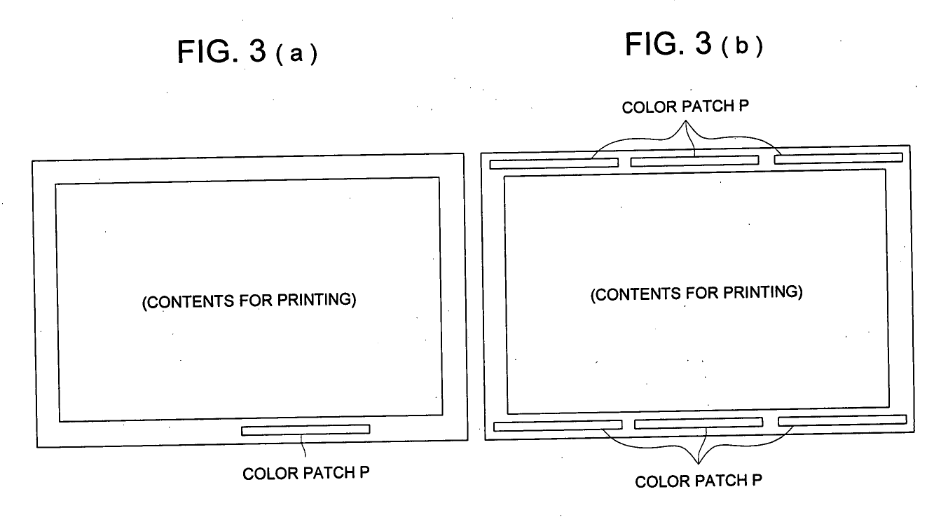

The color patch P is arranged on a periphery of the print contents for printing ordered as shown in FIG. 3, and is attached on a color proof to be outputted. FIG. 3(a) shows an example wherein one color patch P is attached, while, FIG. 3(b) shows an example wherein a plurality of color patches P are attached. Though a color proof for print contents for printing ordered and color patch P may be outputted separately, measurement data as output colors of color proofs are obtained easily and exactly, by measuring the color patch P attached on the color proof and outputted, as in the present example.

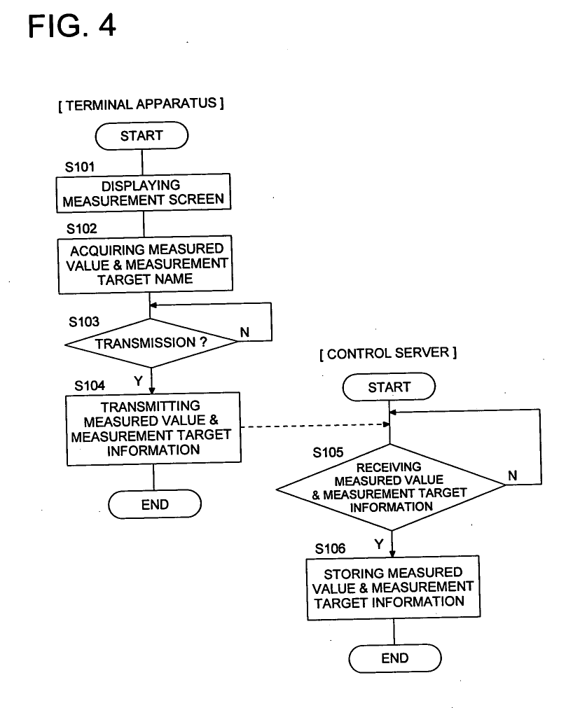

Next, an example of measurement procedures of color patch P will be explained as follows, referring to the drawings. FIG. 4 is a flow chart showing procedures of measurement and storage for color patch P. An example of measuring color patch P shown in FIG. 3(a) is shown as follows, and it is also possible to measure plural color patches P shown in FIG. 3(b) and thereby to use a mean value of respective colors, though explanation is omitted here.

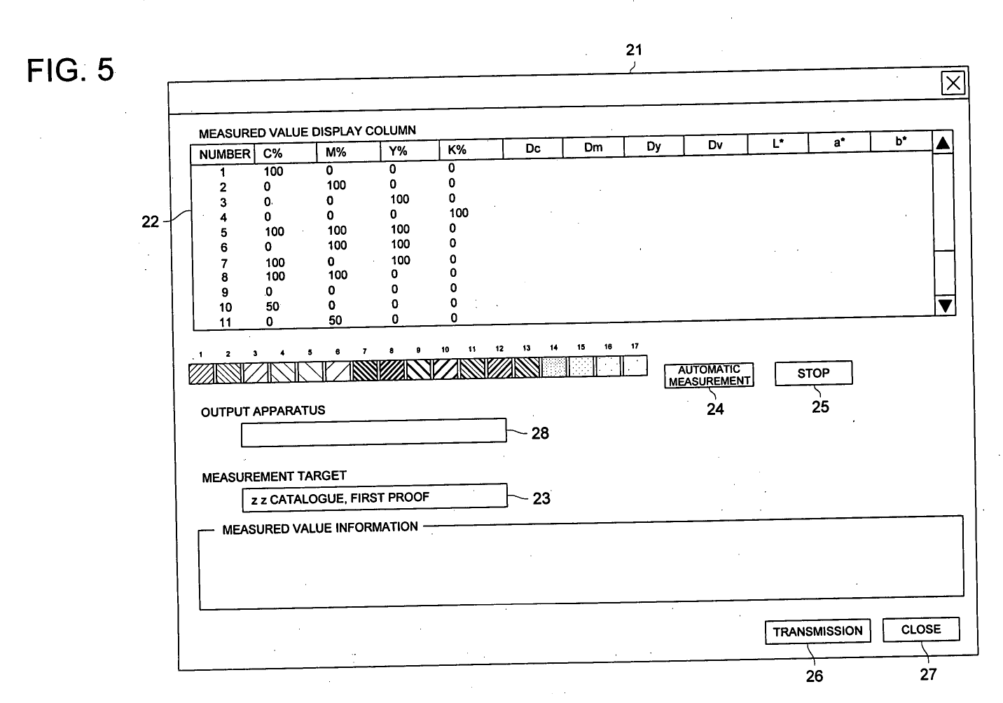

FIG. 4 shows that an operator operates an input section such as a key board and a mouse of terminal apparatus 2 to display measurement screen 21 shown in FIG. 5 on a display section (step S101 representing “step S101” will be abbreviated as “S101” after this. The same text follows for other steps). Then, the operator measures color patch P and inputs a measurement target name to acquire measured values of the color patch P and the measurement target name (S102).

Specifically, when the operator moves a cursor with a mouse and clicks measurement key 24, a standby state for measured values is resulted, and when the operator measures color patches P with colorimeter 3 in the order of numbers, the measured values are displayed on measured value display column 22. Stop key 25 is one to stop measurement. Then, the operator moves a cursor to measurement target input column 23 and inputs a measurement target name by using a key board. For example, in the case of first proof of an order for zz catalog, “zz catalog, first proof” is inputted so that a name of order for the color proof and the outputted sequence may be understood. Therefore, the measurement target name includes a name of the order and the sequence. Further, the output apparatus used is inputted in output apparatus input column 28.

When the operator clicks transmission key 26 (S103, Y) after the measurement and input are finished, the measured value in the measured value display column 22 and the measurement target name in comment column 23 are transmitted to management server 1 (S104), respectively as measurement data and measurement target information, and measurement data, measurement target information, transmission date and time information and sender information showing the site are transmitted. The name of order and the sequence are included in the measurement target information respectively as order information and sequence information.

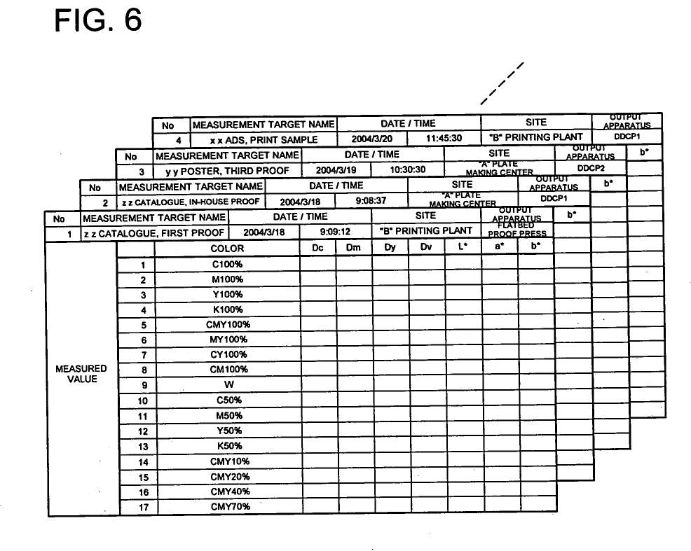

After receiving measurement data and measurement target information (S105, Y), the management server 1 makes the measurement data and the measurement target information to correspond each other, and further makes date and time shown by the transmission date and time information, the site shown by the sender information and the output apparatus to correspond each other, and store them in measurement data storing section 12 through the structure shown in FIG. 6.

Each color proof is measured at the site where the color proof is outputted, and is transmitted to management server 1, in the explanation above. However, for example, it is also possible to measure at a site (for example, a printing company) at one location and to transmit to management server 1, or an administrator who controls management server 1 may measure each color proof to store in the management server 1.

(Procedures of Providing Output Color Comparing Information)

Further, procedures of providing output color comparing information will be explained. A characteristic of the present embodiment is to provide output color comparing information about each order. For example, the output color comparing information is provided when (1) there is a request from the terminal apparatus 2, or, when (2) the aforesaid measured values are transmitted.

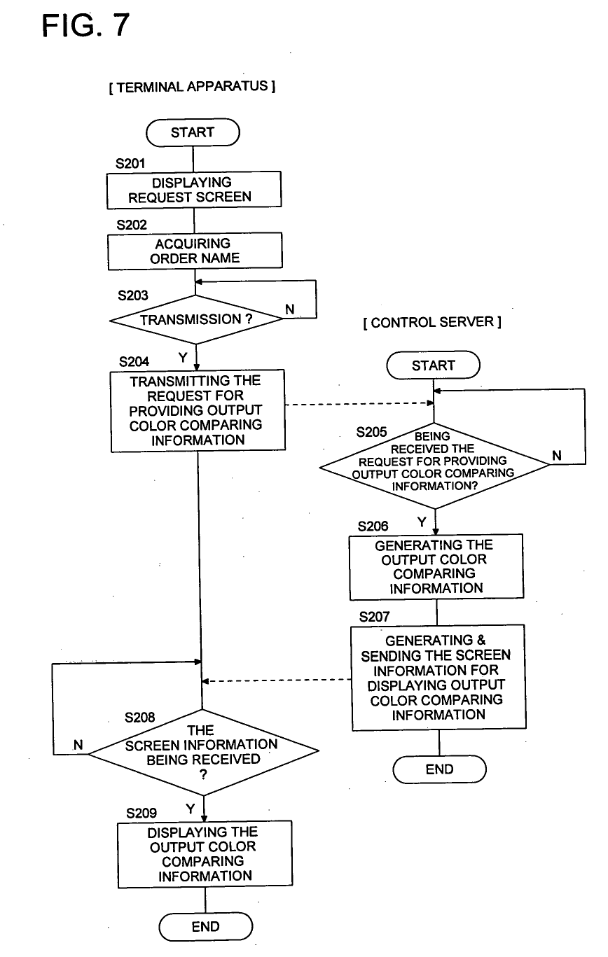

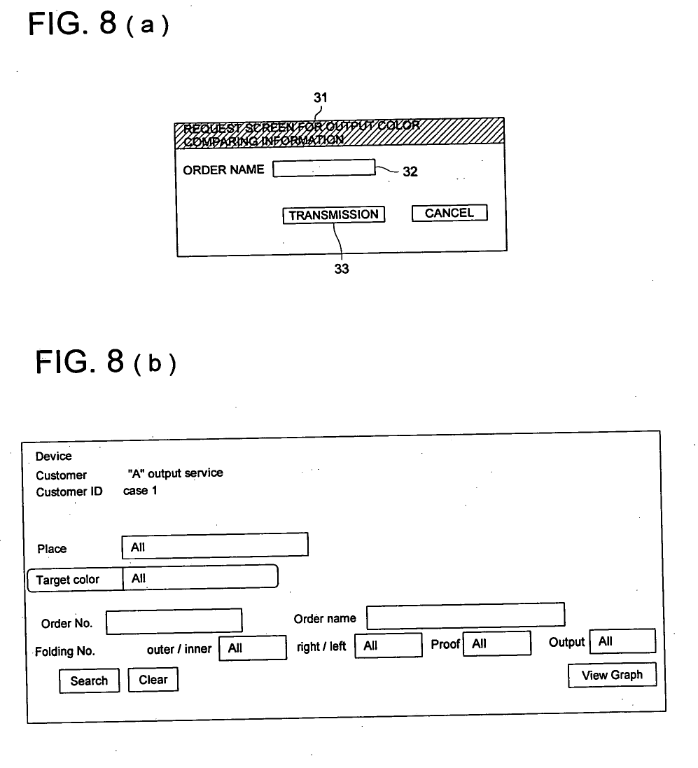

(1) An outline of an example to conduct when there is a request from the terminal apparatus 2 will be explained as follows, referring to the flow chart shown in FIG. 7. For example, the terminal apparatus 2 is made to display request screen 31 shown in FIG. 8(a) (S201). An operator acquires a name of the order (S202) by inputting the name of the order in order name inputting column 32 in which the order name of the request careen 31 can be inputted. If transmission key 33 is clicked (S203, Y), the request for providing output color comparing information is transmitted (S204), and then, management server 1 receives the request for providing output color comparing information S205, Y), then, makes output color comparing information about the inputted order name (details of making output color comparing information will be explained later) (S206), and generates screen information which makes it possible to read output color comparing information to transmit it to the terminal apparatus 2 (S207). The terminal apparatus 2 receives the screen information (S208, Y) and displays output color comparing information on the display section (S209).

FIG. 8(b) shows an example of an input screen for the request of providing more detailed information. Owing to this screen, an operator can narrow down detailed information about a target color such as an output position of the color proof as well as the order name, and can present the request for providing information.

Though output color comparing information is transmitted to the terminal apparatus 2 by means of the screen information in the explanation above, it is also possible, for example, to transmit information in a form of an e-mail to be read on the terminal apparatus 2. In this case, generating section 15 may add a mail address of the terminal apparatus 2 representing a transmission target to the mail including output color comparing information, to send an e-mail through communication section 11.

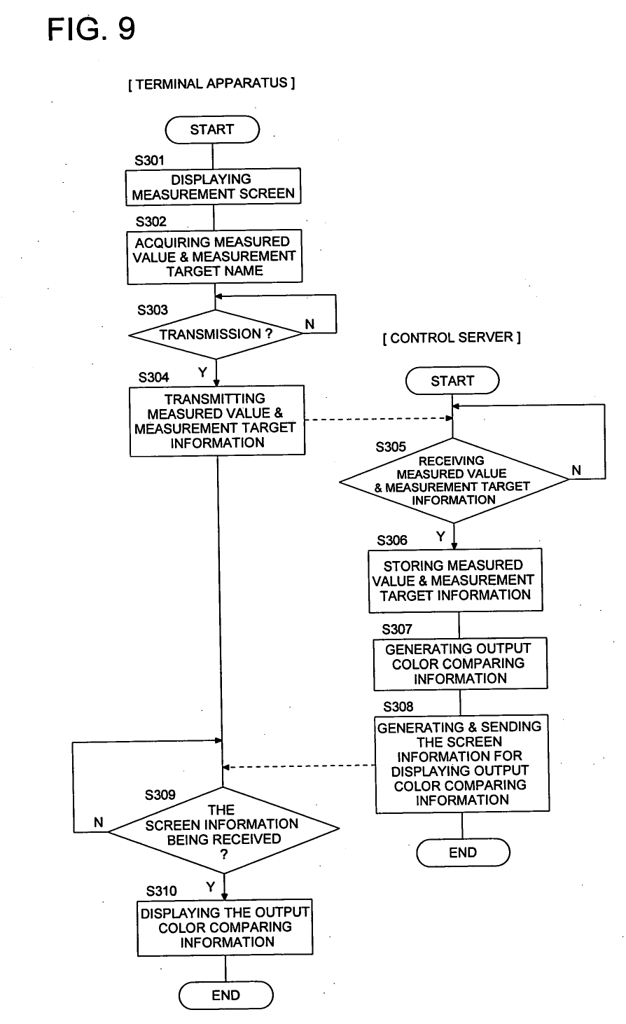

(2) An outline of an example to conduct when measured values are transmitted will be explained as follows, referring to the flow chart shown in FIG. 9. For example, color patch P is first measured as stated in the aforesaid (color management method) and a measurement target name is inputted to transmit to management server 1 in the same way (S301-S304). The management server 1 stores measurement data and measurement target information in measurement data storing section 12 in the same way (S305, S306). Then, it makes (details of making output color comparing information will be explained later) output color comparing information about an order name included in the inputted measurement target name (S307), then, generates screen information for displaying output color comparing information and transmits it to the terminal apparatus 2 (S308). The terminal apparatus 2 receives screen information (S309, Y) and displays output color comparing information on the display section (S310). Though the output color comparing information is transmitted to the terminal apparatus 2 in a form of screen information in the aforesaid explanation, it is also possible, for example, to transmit information in a form of an e-mail to be read on the terminal apparatus 2.

(Procedures of Generating Output Color Comparing Information)

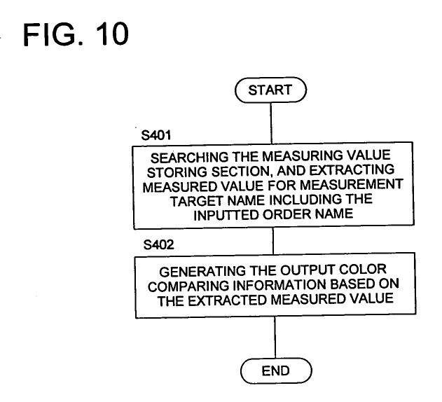

Further, procedures of generating output color comparing information will be explained as follows, referring to FIG. 10. As shown in FIG. 10, measured value extracting section 13 of management server 1 retrieves measured value storing section 12, and extracts measured values including the order name transmitted from the terminal apparatus 2 in the measurement target name. For example, when the order name is “zz catalog”, and measured values including “first proof”, “in-house proof”, “second proof”, “third proof” and “print sample” of the “zz catalog” are stored in the measured value extracting section 13, these are extracted (S401).

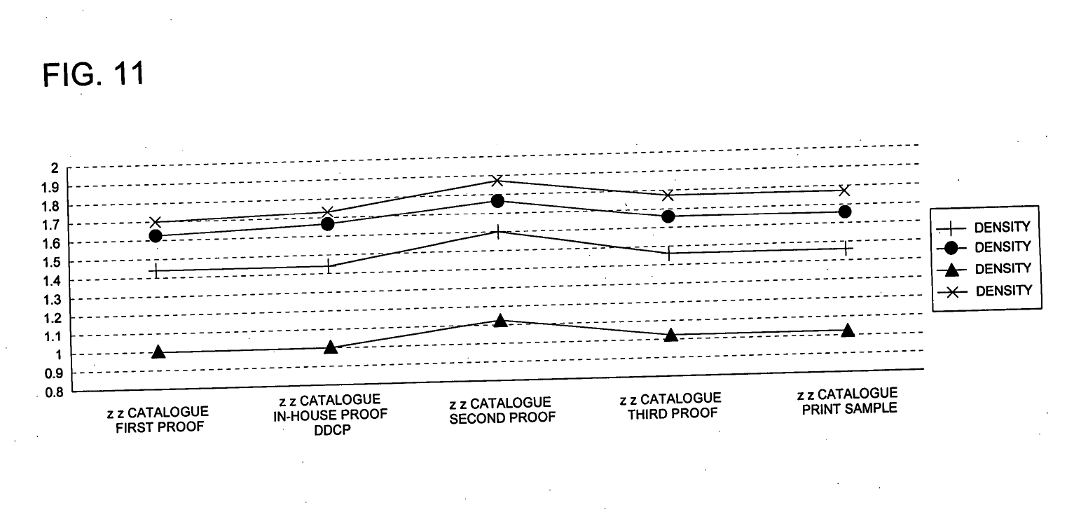

Then, in measured value processing section 14, there is made output color comparing information shown for each of “first proof”, “in-house proof”, “second proof”, “third proof” and “print sample” based on the extracted measured value (S402). Now, examples of output color comparing information to be made are shown in FIG. 11-FIG. 15.

FIG. 11 is an example of a graph displaying “density” as output color comparing information. This graph is one wherein Dv density of each solid (100%) for each of C, M, Y and K of “zz catalog” is shown for each of “first proof”, “in-house proof”, “second proof”, “third proof” and “print sample”. Further, without being limited to the foregoing, a type of the display may also be one wherein any one of “first proof”, “in-house proof”, “second proof”, “third proof” and “print sample” is made to be a reference of density, and a difference from this reference density is displayed. Due to this, output colors of color proofs in each order can be compared in terms of density. This type can be realized easily because a densitometer is an ordinary calorimeter.

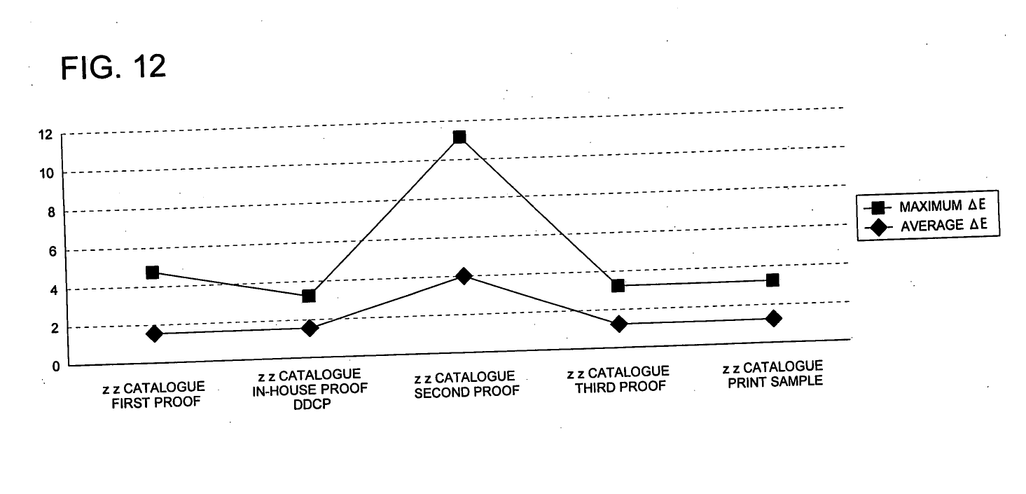

FIG. 12 shows an example of a graph displaying “L*a*b* values in CIE L*a*b* color system” as output color comparing information. This graph is one, as an example, wherein a mean value and the maximum value of color difference ΔE between L*a*b* values of each output color of “ZZ catalog” and L*a*b* values representing a reference established in advance for each output color are shown for each of “first proof”, “in-house proof”, “second proof”, “third proof” and “print sample”. Further, ΔE can be obtained from
ΔE={(ΔL*)\hat{ }2+(Δa*)\hat{ }2+(Δb*)\hat{ }2}\hat{ }(½)
wherein “a\hat{ }b” shows “b^{th} power of a” (the same text follows). Further, without being limited to the foregoing, a type of the display may be one wherein color difference ΔE for each output color is displayed, or it may also be one wherein any one of “first proof”, “in-house proof”, “second proof”, “third proof” and “print sample” is made to be a reference to display with a color difference of the reference.

It is further possible to display a*b* values on a*b* plane and to compare them, without being limited to the color difference. Due to this, output colors of color proofs in each order can be compared in terms of a color difference or a value of a color system, and color deviations can be grasped easily.

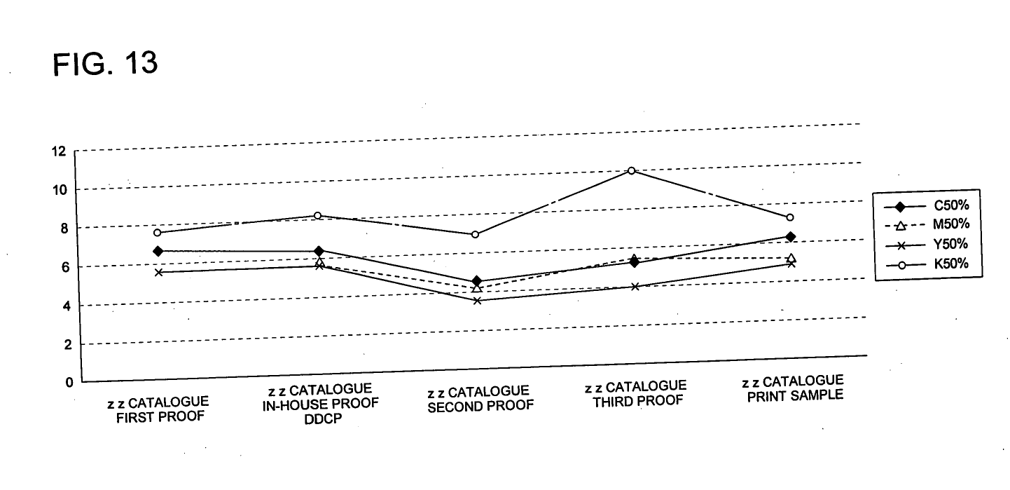

FIG. 13 shows an example of a graph for displaying “dot gain value” showing an amount of changes of a dot size, as output color comparing information. As an example, this graph is one wherein a dot gain value for 50% of each of C, M, Y and K of “zz catalog” is shown for each of “first proof”, “in-house proof”, “second proof”, “third proof” and “print sample”. The dot gain value is obtained in the following manner. An explanation will be given with an example of a dot gain value for each of C50%, M50%, Y50% and K50%.

Let it be assumed here that Wc, Wm, Wy and Wv represent respectively Dc, Dm, Dy and Dv of W (white background), Cc, Cm, Cy and Cv represent respectively Dc, Dm, Dy and Dv of C solid (C 100%), Mc, Mm, My and Mv represent respectively Dc, Dm, Dy and Dv of M solid (M 100%), Yc, Ym, Yy and Yv represent respectively Dc, Dm, Dy and Dv of Y solid (Y 100%), Kc, Km, Ky and Kv represent respectively Dc,. Dm, Dy and Dv of K solid (K 100%), C50c, C50m, C50y and C50v represent respectively Dc, Dm, Dy and Dv of C 50%, M50c, M50m, M50y and M50v represent respectively Dc, Dm, Dy and Dv of M 50%, Y50c, Y50m, Y50y and Y50v represent respectively Dc, Dm, Dy and Dv of Y 50%, and K50c, K50m, K50y and K50v represent respectively Dc, Dm, Dy and Dv of K 50%.

A dot gain value of C 50% can be obtained from “C50% dot gain value=C50% halftone dot %−50”, by obtaining C 50% halftone dot % from “C 50% halftone dot %=100*(1-10\hat{ }(−D2))/(1-10\hat{ }(−D1))” under the assumption of “D1=Cc−Wc” and “D2=C50c−Wc”.

A dot gain value of M 50% can be obtained from “M50% dot gain value=M50% halftone dot %−50”, by obtaining M 50% halftone dot % from “M 50% halftone dot %=100*(1-10\hat{ }(−D2))/(1-10\hat{ }(−D1))” under the assumption of “D1=Mm−Wm” and “D2=M50m−Wm”.

A dot gain value of Y 50% can be obtained from “Y50% dot gain value=Y50% halftone dot %−50”, by obtaining Y 50% halftone dot % from “Y 50% halftone dot %=100*(1-10\hat{ }(−D2))/(1-10\hat{ }(−D1))” under the assumption of “D1=Yy−Wy” and “D2=Y50y−Wy”.

A dot gain value of K 50% can be obtained from “K50% dot gain value=K50% halftone dot %−50”, by obtaining K 50% halftone dot % from “K 50% halftone dot %=100*(1-10\hat{ }(−D2))/(1-10\hat{ }(−D1))” under the assumption of “D1=Kv−Wv” and “D2=K50v−Wv”.

Further, without being limited to the foregoing, a type of the display may also be one wherein any one of “first proof”, “in-house proof”, “second proof”, “third proof” and “print sample” is made to be a reference, to display with a difference from this reference dot gain value. Due to this, output colors of color proofs in each order can be compared in terms of a dot gain value, and a difference in halftone can easily be grasped.

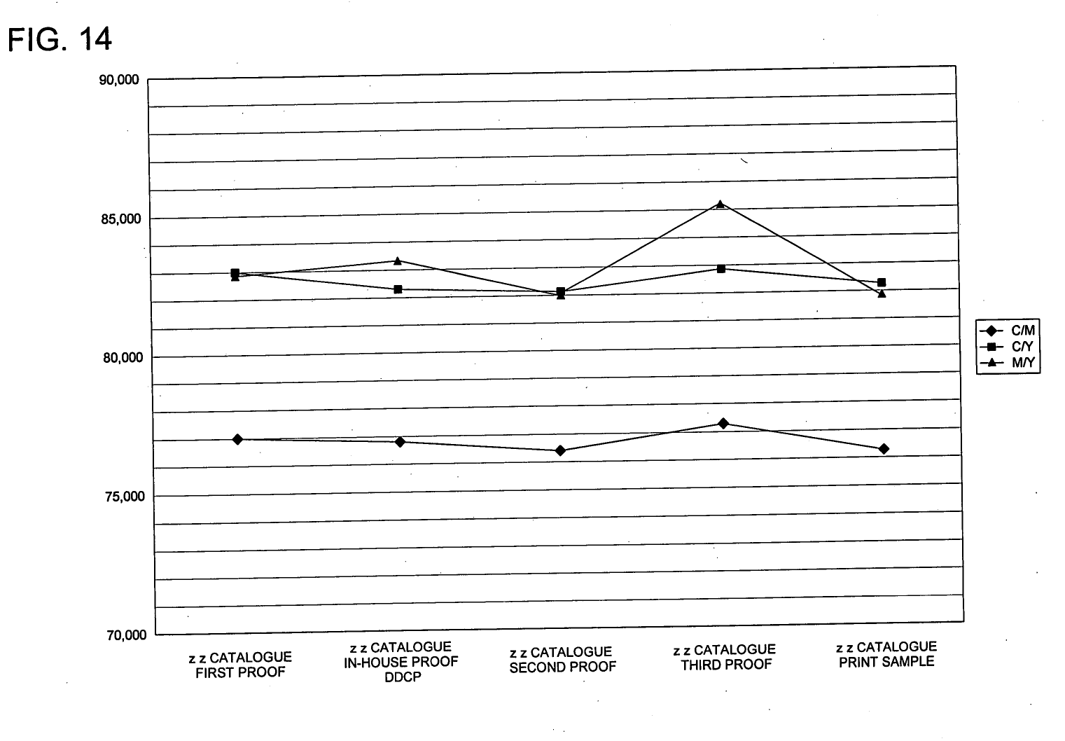

FIG. 14 shows an example of a graph that displays the “trapping rate” showing how much ink for subsequent printing can adhere onto ink for preceding printing, as output color comparing information. In this graph, the sequence of printing is made to be Y→M→C→K, as an example, and trapping rate C/M representing a trapping rate of C on M, trapping rate C/Y representing a trapping rate of C on Y, trapping rate M/Y representing a trapping rate of M on Y, and trapping rate M/Y representing a trapping rate of M on Y all for “zz catalog” are shown for each of “first proof”, “in-house proof”, “second proof”, “third proof” and “print sample”. Each trapping rate is obtained as follows.

Trapping rate C/M representing a trapping rate of C on M is obtained as
Trapping rate C/M=(Bm−Cm)/Mm×100
under the assumption that Bm represents magenta density of B (CM100%), Cm represents magenta density of C solid (C100%) and Mm represents magenta density of M solid (C100%).

Trapping rate C/Y representing a trapping rate of C on Y is obtained as
Trapping rate C/Y=(Gy−Cy)/Yy×100
under the assumption that Gy represents yellow density of G (CY100%), Cy represents yellow density of C solid (C100%) and Yy represents yellow density of Y solid (C100%).

Trapping rate M/Y representing a trapping rate of M on Y is obtained as
Trapping rate M/Y=(Ry−My)/Yy×100
under the assumption that Ry represents yellow density of R (MY100%), My represents yellow density of M solid (M100%) and Yy represents yellow density of Y solid (C100%).

Further, without being limited to the foregoing, a type of the display may also be one wherein any one of “first proof”, “in-house proof”, “second proof”, “third proof” and “print sample” is made to be a reference, to display with a difference from this reference trapping rate. Due to this, output colors of color proofs in each order can be compared in terms of a trapping rate, and a difference in the case of superposing can easily be grasped.

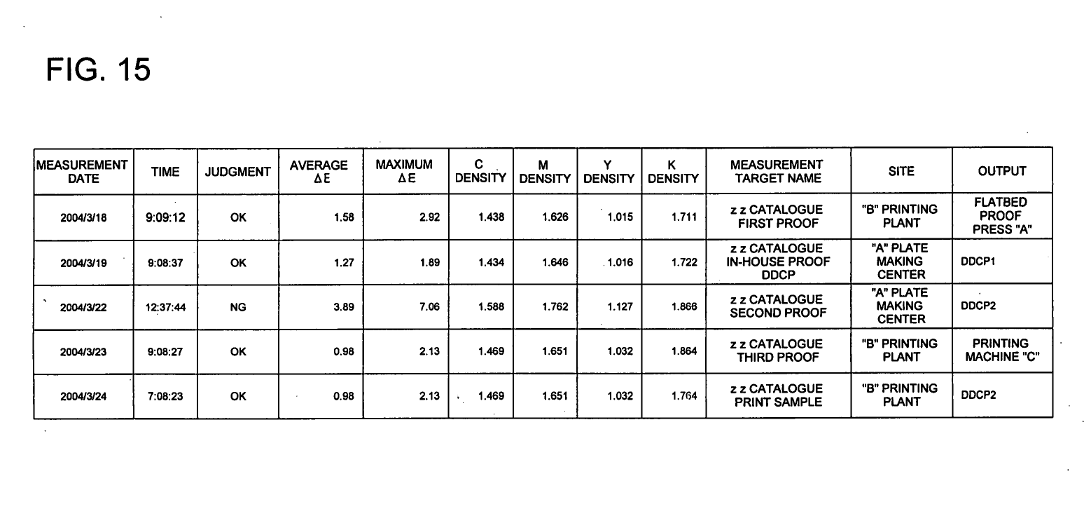

FIG. 15 shows an example of a table showing output color comparing information with OK or NG of the conditions of the output color. This graph is one wherein output colors are judged with OK or NG, for example, and results of the judgment are shown for each of “first proof”, “in-house proof”, “second proof”, “third proof” and “print sample”. When forming a judgment, a comparison is made with a criterion for judgment established in advance about density, a color difference, a dot gain value or a trapping rate, for example, with a criterion of “Mean value ΔE for the color difference from a criterional color shall be 3 or less” or with a criterion of “Density difference from a criterional color shall be within ±0.1”, then, each color is judged whether it satisfies the criterion for judgment or not, and if an output color of not satisfying the criterion is found, judgment “NG” is marked as shown in FIG. 15. In this way, a color proof that is in conformity with the criterion or a color proof that is not in conformity can be recognized at a glance.

Further, the output color comparing information to be generated and provided is assumed to be one or plural pieces of the output color comparing information. Or, it is possible to arrange so that output color comparing information may be selected by an unillustrated request screen 31, though this is not illustrated, and the selected output color comparing information may be generated and provided.

1. A color management system for controlling output colors of plural color proofs outputted in succession during a period from receiving of an order of printing to finishing of a printing for the order, the color management system comprising:
a measuring section to measure an output color of a color proof of the plural color proofs;
a storing section to store a measured value of the output color of the color proof measured by the measuring section, and sequence information for identifying a sequential order in which the measured output color of the color proof is outputted, in such a way that the measured values and the sequence information correspond each other; and
an information generating section to generate information showing a condition of the output color for each of the sequential order based on the measured values stored in the storing section.

2. The color management system of claim 1, wherein the storing section stores the measured value of the output color of the color proof measured by the measuring section, order information for identifying the order of printing for which the measured output color of the color proof is outputted, and the sequence information for identifying a sequential order in which the measured output color of the color proof is outputted, in such a way that the measured values, the order information, and the sequence information correspond with each other; and
the information generating section receives the order information representing one order, extracts the measured value corresponding to the one order from the storing section, and generates information showing the condition of the output color for each of the sequential order corresponding to the one order based on the extracted measured value.

3. A color management system for controlling output colors of plural color proofs outputted at any one of plural sites in succession during a period from receiving of an order of printing to finishing of a printing for the order, the color management system comprising:
plural terminal apparatuses which are arranged on respective sites, each of the plural terminal apparatuses having:
a measuring section to measure an output color of a color proof of the plural color proofs;
a measured value transmitting section to transmit a measured value of the output color of the color proof measured by the measuring section, order information for identifying the order of printing for which the color proof is outputted, and sequence information for identifying a sequential order in which the color proof is outputted; and
a control server connected with the plural terminal apparatuses through a network, the control server having:
a storing section stores the measured value and the sequence information transmitted, in such a way that the measured value and the sequence information correspond to each other;
an information generating section to generate information showing a condition of the output color for each of the sequential order to be browsed by the terminal apparatuses, based on the measured values stored in the storing section.

4. The color management system of claim 3, wherein the storing section stores the measured value, order information and the sequence information transmitted, in such a way that the measured value, order information and the sequence information correspond to each other; and
the information generating section receives the order information representing one order, extracts the measured value corresponding to the one order from the storing section, and generates information, to be browsed by the terminal apparatuses, showing the condition of the output color for each of the sequential order corresponding to the one order based on the extracted measured value.

5. The color management system of claim 1, wherein the condition of the output color is represented by any one of a density value, a value of a color system, a dot gain value and a trapping rate.

6. The color management system of claim 3, wherein the condition of the output color is represented by any one of a density value, a value of a color system, a dot gain value and a trapping rate.

7. The color management system of claim 1, wherein the color proof is outputted with a color patch attached to the color proof, the color patch including one or plural colors, wherein the output color of the color proof is measured by measuring the color patch.

8. The color management system of claim 3, wherein the color proof is outputted with a color patch attached to the color proof, the color patch including one or plural colors, wherein the output color of the color proof is measured by measuring the color patch.

9. A color management method for controlling output colors of plural color proofs outputted in succession during a period from receiving of an order of printing to finishing of a printing for the order, the color management method comprising the steps of:
measuring an output color of a color proof of the plural color proofs;
storing a measured value of the output color of the color proof measured by the measuring section, and sequence information for identifying a sequential order in which the measured output color of the color proof is outputted, in such a way that the measured values and the sequence information correspond each other; and
generating information showing a condition of the output color for each of the sequential order based on the measured values stored in the storing section.

10. The color management method of claim 9, wherein the storing step stores the measured value of the output color of the color proof measured by the measuring section, order information for identifying the order of printing for which the measured output color of the color proof is outputted, and the sequence information for identifying a sequential order in which the measured output color of the color proof is outputted, in such a way that the measured values, the order information, and the sequence information correspond with each other; and
the generating step receives the order information representing one order, extracts the measured value corresponding to the one order from the storing section, and generates the information showing the condition of the output color for each of the sequential order corresponding to the one order based on the extracted measured value.

11. A color management method for controlling output colors of plural color proofs outputted at any one of plural sites in succession during a period from receiving of an order of printing to finishing of a printing for the order, by using plural terminal apparatuses which are arranged on respective sites, and a control server connected with the plural terminal apparatuses through a network, the color management method comprising:
(i) at the plural terminal apparatuses,
measuring an output color of a color proof of the plural color proofs;
transmitting a measured value of the output color of the color proof measured, order information for identifying the order of printing for which the color proof is outputted, and sequence information for identifying a sequential order in which the color proof is outputted; and
(ii) at the control server,
storing the measured value and the sequence information transmitted, in such a way that the measured value and the sequence information correspond to each other;
generating information showing a condition of the output color for each of the sequential order to be browsed by the terminal apparatuses, based on the measured values stored in the storing section.

12. The color management method of claim 11, wherein the storing step stores the measured value, order information and the sequence information transmitted, in such a way that the measured value, order information and the sequence information correspond to each other; and the generating step receives the order information representing one order, extracts the measured value corresponding to the one order, and generates information, to be browsed by the terminal apparatuses, showing a condition of the output color for each of the sequential order corresponding to the one order based on the extracted measured value.

13. The color management method of claim 9, wherein the condition of the output color is represented by any one of a density value, a value of a color system, a dot gain value and a trapping rate.

14. The color management method of claim 11, wherein the condition of the output color is represented by any one of a density value, a value of a color system, a dot gain value and a trapping rate.

15. The color management method of claim 9, wherein the color proof is outputted with a color patch attached to the color proof, the color patch including one or plural colors, wherein the output color of a color proof is measured by measuring the color patch.

16. The color management system of claim 11, wherein the color proof is outputted with a color patch attached to the color proof, the color patch including one or plural colors, wherein the output color of a color proof is measured by measuring the color patch.
